(19) United States
(12) Patent Application Publication
(10) Pub. No.: US 2008/0027811 A1
(43) Pub. Date: Jan. 31, 2008

(54) CUSTOM DOCUMENT GENERATION SYSTEM AND METHOD

(76) Inventor: Rich Voslow, Seattle, WA (US)

Correspondence Address: AXIOS LAW GROUP. PLLC, 1525 FOURTH AVENUE, SUITE 800, SEATTLE, WA, 98101, US

(21) Appl. No.: 11/828,968

(22) Filed: Jul. 26, 2007

Related U.S. Application Data
(60) Provisional application No. 60/820,936, filed on Jul. 31, 2006.

(51) Int. Cl. G06Q 30/00

(52) U.S. Cl. 705/14

(57) ABSTRACT

A custom marketing document system and method, including custom map information is provided herein.

### BACKGROUND

Conventional printed marketing materials that are sent to customers generally contain static marketing information and possibly some customized text information. For example, printed marketing information may take the form of letters, cards and/or brochures that include a customer's name, address or other textual information about a customer. Similarly some forms of online advertising allow for customers to request dynamic information once they have received online marketing materials. For example, if a user receives an electronic invitation from “Evite” from IAC/InterActiveCorp of New York, N.Y., there may be a link to obtain a map from a specified online mapping provider to an event associated with the Evite. Generally the maps that are available online from online mapping providers such as MapQuest of Denver, Colo., do not provide a high enough quality map for printed materials.

Additionally, communication networks are well known in the computer communications field. By definition, a network is a group of computers and associated devices that are connected by communications facilities or links. Network communications can be of a permanent nature, such as via cables, or can be of a temporary nature, such as connections made through telephone or wireless links. Networks may vary in size, from a local area network (“LAN”), consisting of a few computers or workstations and related devices, to a wide area network (“WAN”), which interconnects computers and LANs that are geographically dispersed, to a remote access service, which interconnects remote computers via temporary communication links. An inter-network, in turn, is the joining of multiple computer networks, both similar and dissimilar, by means of gateways or routers that facilitate data transfer and conversion from various networks. A well-known abbreviation for the term inter-network is “internet.” As currently understood, the capitalized term “Internet” refers to the collection of networks and routers that use the Internet Protocol (“IP”), along with higher-level protocols, such as the Transmission Control Protocol (“TCP”) or the Uniform Datagram Packet (“UDP”) protocol, to communicate with one another.

### BREIF DESCRIPTION OF THE DRAWINGS

FIG. 1 illustrates an exemplary Custom Document Generation System in accordance with one embodiment.

FIG. 2 illustrates an exemplary Customization Server in accordance with one embodiment.

FIG. 3 illustrates a Customized Document Creation Routine in accordance with one embodiment.

FIG. 4 illustrates a Custom Map Generation Sub-Routine in accordance with one embodiment.

FIG. 5 illustrates a Custom Document Generation Sub-Routine in accordance with one embodiment.

FIG. 6 illustrates an exemplary Custom Marketing Document Template in accordance with one embodiment.

FIGS. 7a and 7b illustrate an exemplary Custom Marketing Document in accordance with one embodiment.

### DETAILED DESCRIPTION

The detailed description that follows is represented largely in terms of processes and symbolic representations of operations by conventional computer components, including a processor, memory storage devices for the processor, connected display devices and input devices. Furthermore, these processes and operations may utilize conventional computer components in a heterogeneous distributed computing environment, including remote file Servers, computer Servers and memory storage devices. Each of these conventional distributed computing components is accessible by the processor via a communication network.

Reference is now made in detail to the description of the embodiments as illustrated in the drawings. While embodiments are described in connection with the drawings and related descriptions, there is no intent to limit the scope to the embodiments disclosed herein. On the contrary, the intent is to cover all alternatives, modifications and equivalents. Those of ordinary skill in the art will appreciate that other embodiments, including additional devices, or combinations of illustrated devices, may be added to, or combined, without limiting the scope to the embodiments disclosed herein.

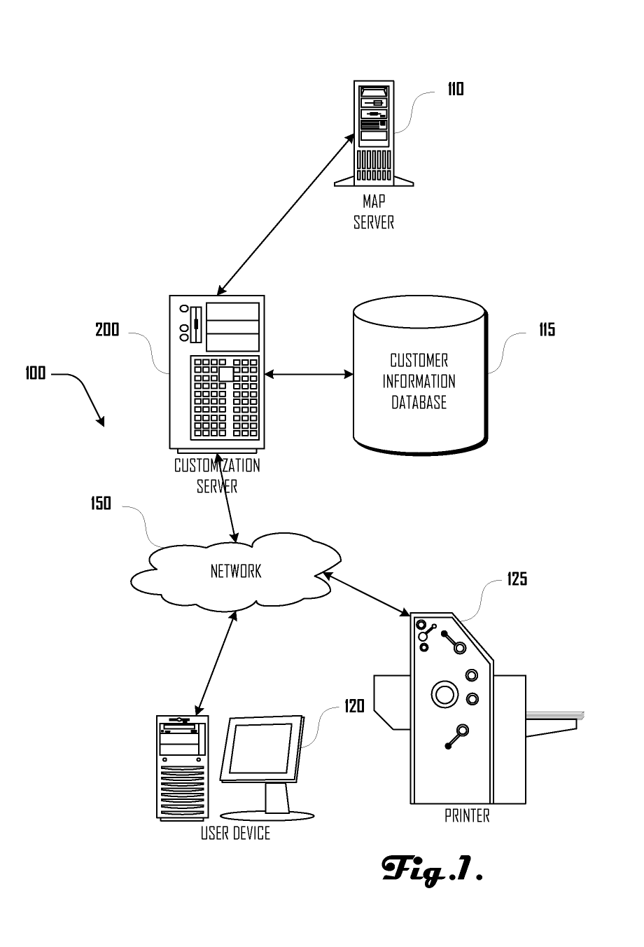

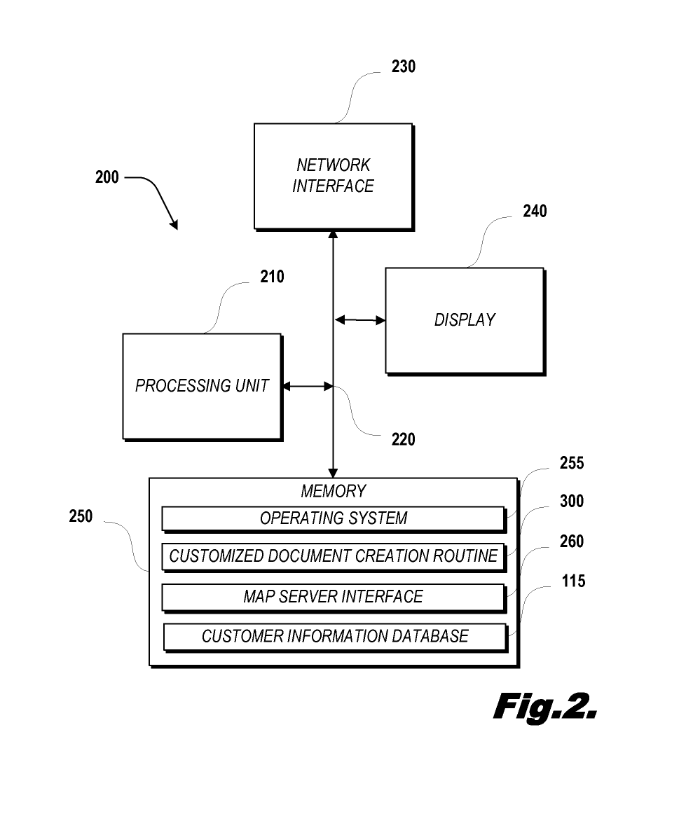

FIG. 1 illustrates an exemplary Custom Document Generation System 100 having a number of devices used in exemplary embodiments. FIG. 1 illustrates a Printer 125 (such as a variable data printing press) connected via a Network 150 User Device 120 and a Customization Server 200, illustrated in FIG. 2 and described below. Also included are a Map Server 110 and a Customer Information Database 115.

In alternate embodiments, there may be a plurality of Map Server 110, or even that the role of the Map Server 110 may be performed by another device such as the Customization Server 200. In further embodiments, still additional devices (not shown) may be utilized in the Custom Document Generation System 100. For example, the Customer Information Database 115 may be located on a separate device than the Customization Server 200. Likewise, in some embodiments, other devices (both shown and not shown) may be combined. For example, the Printer 125 and User Device 120 may be merged into a single device.

An example listing of Variable Data Printing Presses suitable for use in various embodiments includes, but is not limited to:
Xeikon (Xeikon 5000)
Océ (Océ VarioPrint 6250)
Xerox (DocuColor series presses)
Xanté Corp. (Xanté's Ilumina digital color press)
Canon (Canon presses)
Kodak (Kodak NexPress 2100 and 2500 presses and Kodak Digimaster systems)
HP (HP Indigo presses)
MGI Digital Graphic Technologies (Meteor DP 40 series)

FIG. 2 illustrates several of the components of the Customization Server 200. In some embodiments, the Customization Server 200 may include many more components than those shown in FIG. 2. However, it is not necessary that all of these generally conventional components be shown in order to disclose an illustrative embodiment. As shown in FIG. 2, the Customization Server 200 includes a Network Interface 230 for connecting to other devices in the Custom Document Generation System 100. In various embodiments, the Network Interface 230 includes the necessary circuitry for such a connection and is constructed for use with the appropriate protocol.

The Customization Server 200 also includes a Processing Unit 210, a Memory 250 and may include a Display 240, all interconnected along with the network interface 230 via a Bus 220. The Memory 250 generally comprises a random access memory (“RAM”), a read only memory (“ROM”), and a permanent mass storage device, such as a disk drive. The Memory 250 stores the program code necessary for a Customized Document Creation Routine 300, a Map Server Interface 260, and possibly a Customer Information Database 115. In addition, the Memory 250 also stores an Operating System 255. It will be appreciated that these software components may be loaded from a computer readable medium into Memory 250 of the Customization Server 200 using a drive mechanism (not shown) associated with a computer readable medium, such as a floppy disc, tape, DVD/CD-ROM drive or via the Network Interface 230.

Although an exemplary Customization Server 200 has been described that generally conforms to conventional general purpose computing devices, those of ordinary skill in the art will appreciate that a Customization Server 200 may be of any great number of devices capable of communicating with the device within the Custom Document Generation system 100.

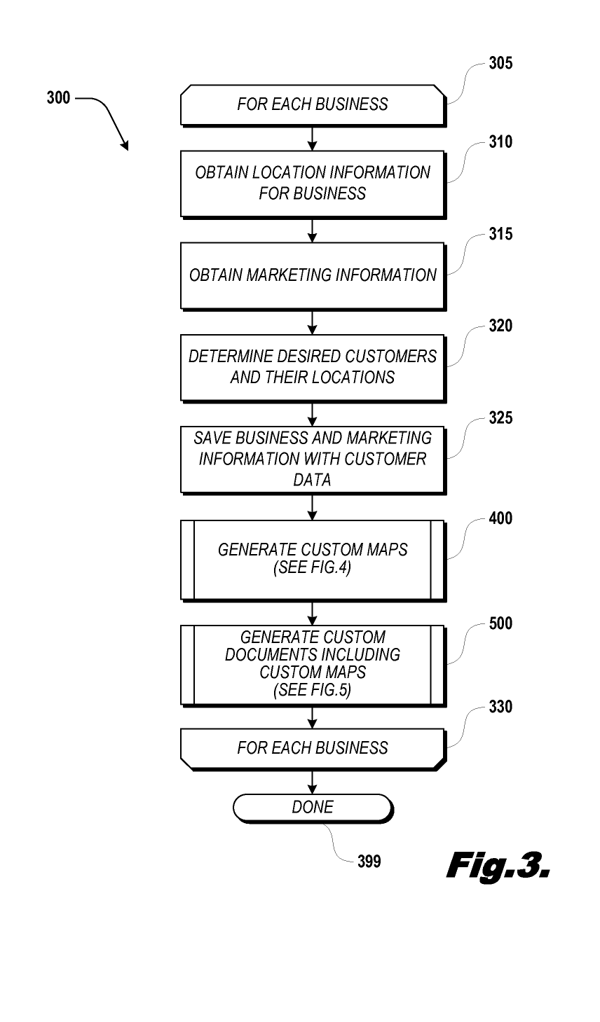

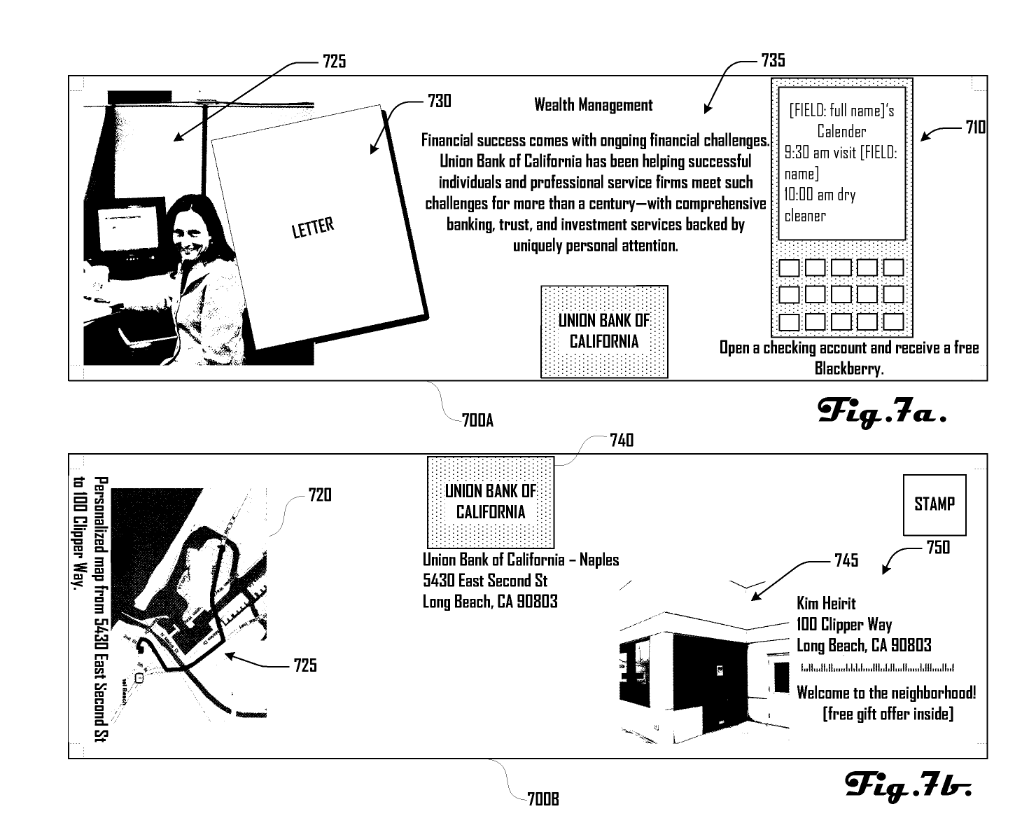

FIG. 3 illustrates an exemplary Customized Document Creation Routine 300. Customized Document Creation Routine 300 is used to create documents that have dynamic marketing information that is targeted to a specific customer and/or customer address. Customized Document Creation Routine 300 begins at looping block 305 which begins in iteration for each business for which marketing documents are being created. Next in Location Information 310 is obtained for the business. In block Marketing Information 315 for the business is obtained. FIGS. 7a and 7b illustrate an exemplary Custom Marketing Document 700A and 700B that includes exemplary marketing information 710, 725, 730, 735, 740, 745, 750, 722, and 720.

In block 320, desired customers and their locations are determined. In one exemplary embodiment determining desired customers and their locations includes querying a Customer Information Database 115 to locate customer's proximate to the location of the current business. In additional embodiment, determining desired customers may involve other processes, such as determining if a customer has already been designated as a desired customer at an alternate business and possibly making a determination as to which customers are better suited for a particular business location.

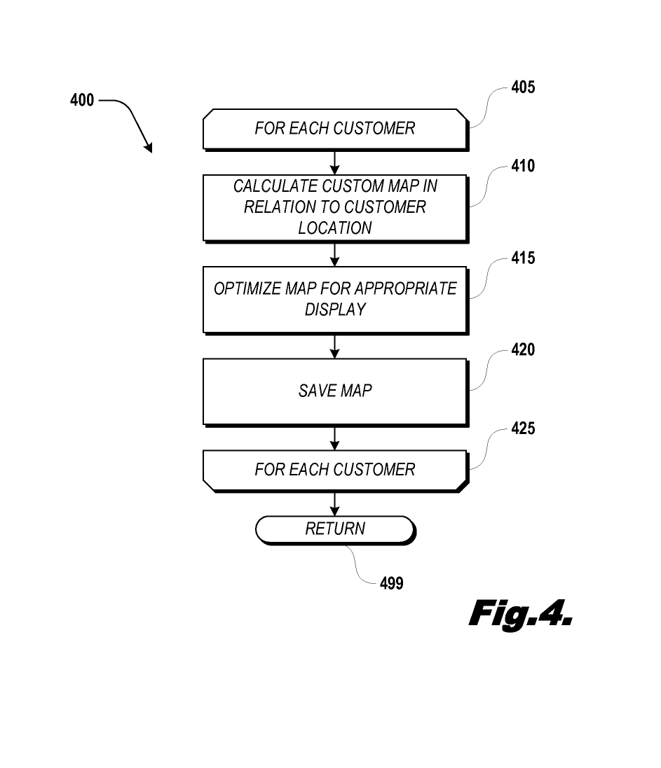

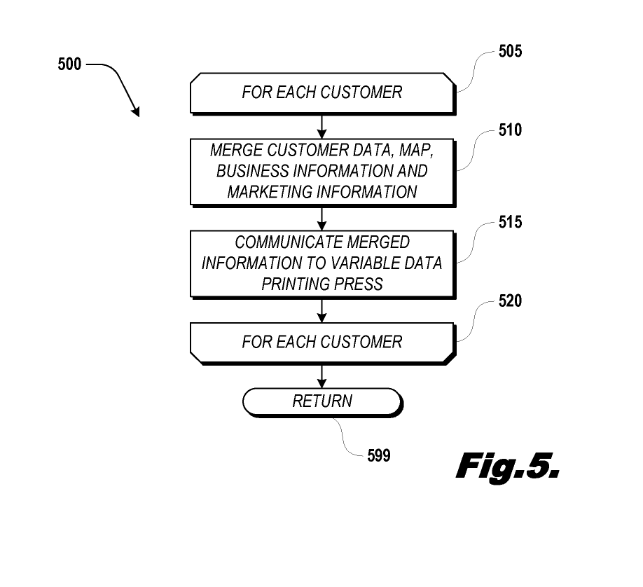

In a further embodiment, Desired Customers 320 may have been predetermined such that a list of desired customers and their locations is available for each business. In block 325, business and marketing information is saved with the customer data for use in creating customer-marketing documents as described below. Next in Custom Map Generation Sub-Routine 400, custom maps for each customer and business are generated. Custom Map Generation Sub-Routine 400 is illustrated in FIG. 4 and described below. Once a custom map has been generated, processing proceeds to Custom Document Generation Sub-Routine 500 where the custom marketing documents including custom maps are generated. Custom Document Generation Sub-Routine 500 is illustrated in FIG. 5 and described below. Upon returning from Custom Documents Generation Sub-Routine 500, processing proceeds to looping block 330 which cycles back to looping block 305 until all businesses have been iterated through, after which processing proceeds to block 399 where dynamic document creation routine 300 ends.

FIG. 4 illustrates an exemplary Custom Map Generation Sub-Routine 400. Custom Map Generation Sub-Routine 400 begins at For Each Customer 405 which iterates through each provided customer. In Calculate Custom Map In Relation to Customer Location 410 a custom map is calculated in relation to the provided business and current customer location. In one exemplary embodiment, the custom map may simply indicate a location of the customer and a location of the business. In an alternate embodiment, the custom map may include a travel route between the customer location and the designated business. In another embodiment, a custom map may include more than a single location for a business such that a user may choose between a number of business locations (e.g., those locations within a predetermined radius of the customer's location).

Next, in Optimize Map for in Relation to Customer Location 415, the calculated custom map is optimized for an appropriate display. In various embodiments, the display medium for the custom map is in a printed format and accordingly if the custom map has been calculated to be displayed on a lower resolution terminal device such as a computer monitor, optimizing the map for appropriate display may include adjusting the resolution of the custom map such that it would be suitable for printing at a higher resolution.

Alternately, the optimization for an appropriate display may include formatting and/or cropping of regions of a custom generated map that do not provide either customer, business or route information. It will be appreciated that in further embodiments, alternate display mediums other than printed technologies may be suitable when delivering custom document to a customer.

In block 420, the custom map is saved. In one exemplary embodiment, the custom map is saved to a database (or other suitable data storage) along with the customer information (e.g., name, address, age, marital status, other demographic information and the like). In some embodiments, the saved customer information and custom maps may be reused in a subsequent document generation without having to recreate custom maps for each customer and business. However, in other embodiments, saving the custom map may only be a transient process to provide the Custom Document Generation Sub-Routine 500 with custom map information that may not be used thereafter.

After the custom map has been saved, processing proceeds to looping block 425 where processing cycles back to looping block 405 until each customer has been iterated through. Next, Custom Map Generation Sub-Routine 400 returns to its calling routine in Return 499.

FIG. 5 illustrates an exemplary Custom Document Generation Sub-Routine 500. Custom Document Generation Sub-Routine 500 begins at looping block 505 which iterates through each provided customer. In Merge Customer Data, Map, Business Information and Marketing Information 510, customer data, custom map, business information and marketing information are merged in a predetermined format (e.g. a Document Template 600) to create an electronic version of a Custom Marketing Document 700A and 700B as shown in FIG. 7a-b. In Communicate Merged Information to Variable Data Printing Press 515, the merged information (i.e. the Custom Marketing Document 700 A and 700B) is communicated to an appropriate rendering/display device such as a variable data printing press or Printer 125 for rendering. Next, in looping block 520, processing cycles back to looping block 505 until each customer has been iterated through, after which processing proceeds to Return 599 which returns to the calling routine.

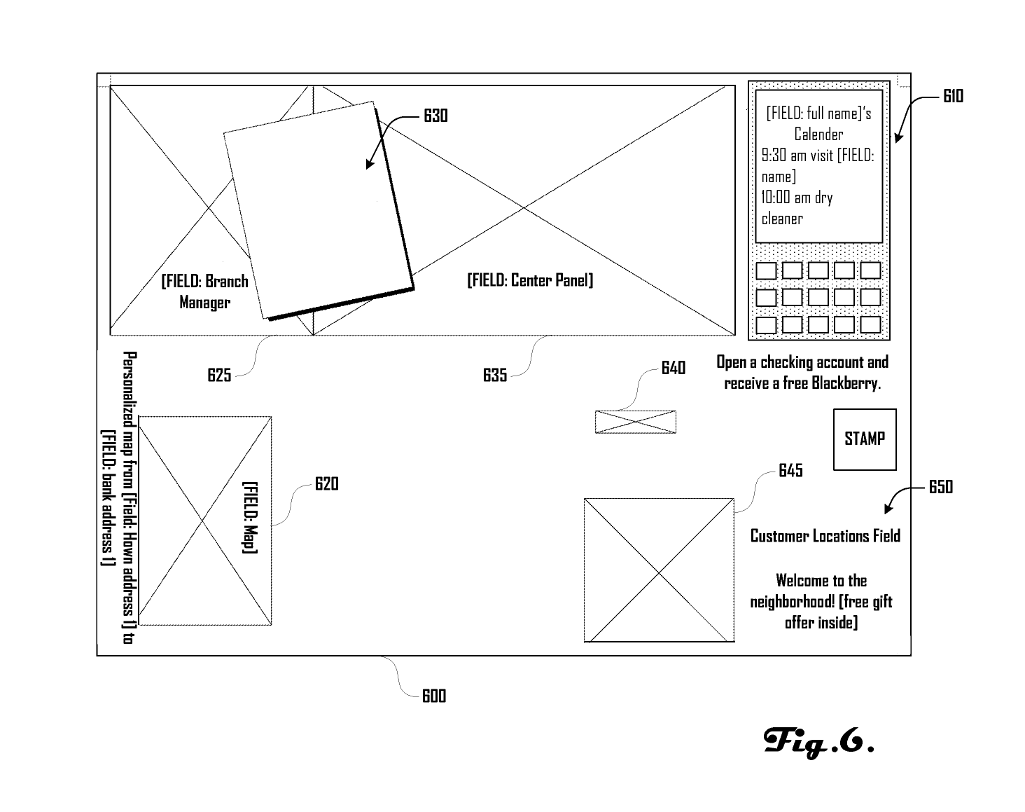

FIG. 6 illustrates an exemplary Custom Marketing Document Template 600. Included in the Template 600 are a number of fields that may contain customized information. For example, Promotion Field 610 includes the ability to specify text within a graphical image. Marketing Field 630 also includes the ability to include text and/or graphical information (e.g. a signature). Similarly, a Logo Field 640, a Front Door Field 645 and a Branch Manager Field 625 may include suitable graphical marketing information. A Center Panel Field 635 may include graphical or textual information as appropriate. Also included of course is a location for a Custom Map Field 620 and Customer Locations Field 650.

FIG. 7a-b illustrates an exemplary Custom Marketing Document 700A and 700B that may be produced by a suitable template such as Template 600. As can be seen in FIG. 7a-b on one side 700A an Image 725 has been included to provide graphical marketing information. Also included is customized textual and graphic information in a Letter 730 along with useful textual and logo information in a Center Panel 735. Similarly, the Promotion Information 710 has been customized with a customer's information and the businesses' information. Included in the Custom Map Panel 720 on the other side of Custom Marketing Document 700B is Route Information 722 between a customer location and a business location. As noted above, other Graphical Information 745 and Logo Information 740 are included along with customer Location Information 750 to allow delivery to a customer.

Although specific embodiments have been illustrated and described herein, it will be appreciated by those of ordinary skill in the art that a wide variety of alternate and/or equivalent implementations may be substituted for the specific embodiments shown and described without departing from the scope of the present invention. This application is intended to cover any adaptations or variations of the embodiments discussed herein.

What is claimed is:

1. A custom marketing document system and method, including custom map information as shown and described.
